(19) United States
(12) Patent Application Publication
(10) Pub. No.: US 2006/0166005 A1
(43) Pub. Date: Jul. 27, 2006

(54) Resin layer-coated copper foil and multilayer printed wiring board obtained with the resin layered-coated copper foil

(75) Inventors: Tetsuro Sato, Saitama (JP); Noriyuki Nagashima, Saitama (JP)

Correspondence Address: ROTHWELL, FIGG, ERNST & MANBECK, P.C., 1425 K STREET, N.W., SUITE 800, WASHINGTON, DC, 20005, US

(73) Assignee: MITSUI MINING & SMELTING CO., LTD, TOKYO (JP)

(21) Appl. No.: 10/523,698

(22) PCT Filed: Aug. 14, 2003
(86) PCT No.: PCT/JP03/10330

§ 371 Date: Feb. 3, 2005

(30) Foreign Application Priority Data
Aug. 22, 2002 (JP) 2002-242618

(51) Int. Cl. B32B 15/08; B32B 27/38

(52) U.S. Cl. 428/418; 428/901

(57) ABSTRACT

The present invention provides a resin-coated copper foil, which does not form a crack in the filled resin layer due to thermal shock in a soldering step or the like, when the resin of the resin-coated copper foil has filled via holes. The present invention provides a resin-coated copper foil having the resin layer on one side of the copper foil, wherein the resin composition of the resin layer comprises (1) 20 to 70 parts by weight of an epoxy resin, (2) 5 to 30 parts by weight of a high polymer having a crosslinkable functional group in the molecule and a crosslinking agent therefor in combination, and (3) 10 to 60 parts by weight of a compound having a structure shown in Formula 1. 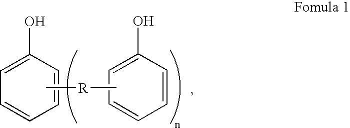 wherein n is an integer of one or more.

### TECHNICAL FIELD

The present invention relates to a resin-coated copper foil, and a multilayer printed wiring board using the resin-coated copper foil.

### BACKGROUND ART

Conventionally, a resin-coated copper foil used for manufacturing a multilayer printed wiring employs an epoxy resin as a main component for the resin layer in many cases, and thereby acquires superior electrical characteristics and insulation reliability between layers. At the same time, the resin-coated copper foil has been widely used for the material of a build-up multilayer printed wiring board on the assumption that a via hole is formed by laser processing.

A process for producing a multilayer printed wiring board with the use of a resin-coated copper foil win be plainly described below. Specifically, the multilayer printed wiring board is produced by further layering a resin-coated copper foil on an inner layer material having a circuit previously formed on one side or both sides of a copper-clad laminate or a multilayer printed wiring board, and by etching the layer material for forming a circuit. In the process, when a printed wiring board having a higher density circuit is produced, an inner layer material called an IVH (an interstitial via hole) substrate is commonly used, which has a through hole formed in the inner layer material, and fills it with copper by plating to secure electrical conduction between layers.

Then, the through hole needs to be completely filled by some method before the IVH substrate is mounted on a final product as a component. If the hole remains in a printed wiring board merely as a void, in a step of applying a high temperature such as in soldering conducted when mounting an electronic component on the printed wiring board, air and moisture existing in the void may suddenly expand, damage and potentially destroy a circuit and the printed wiring board.

As for a method for filling a through hole, a method for applying a filling ink containing an epoxy resin as a main component by printing, or a method for making a resin component of a resin-coated copper foil flow into the through hole while strictly controlling the condition of hot-press, has been investigated.

However, these methods have caused various operational problems. For instance, in a method for printing a filling ink, the ink has to be printed on the position matching to a fine through hole having a diameter of 250 μM or smaller, then the ink is generally considered to hardly fill the fine holes uniformly, and besides the positioning for printing is extremely difficult. Consequently, the filling ink overflows around the through hole. For this reason, a step for removing the overflowed filing ink by polishing needs to be prepared, which causes a problem of increasing a total production cost.

On the other hand, in a method for filling a through hole by using a resin-coated copper foil, the through hole is filled by merely bonding the resin-coated copper foil to the surface of an inner layer material, so that it has an advantage of causing no problem with positioning. However, the method may cause crack in a filled resin layer, because when the above described electronic component is mounted on the above described product, a thermal shock is given to the resin layer in the step of adding high temperature such as soldering, and the resin filled in the through hole thermally expands and shrinks, so that the improvement has been required. In addition, in the method of filling the through hole with the resin of the resin-coated copper foil, the resin shrinks during its curing, pulls the copper foil of the resin-coated copper foil bonded at the position corresponding to the through hole toward a through hole direction, and may produce a recess. This makes an etching resist layer if being formed inadequately adhere to the copper foil in the recess part, in the step of forming a circuit, and may make the etching resist layer be peeled in the recess part. Consequently, the recess part makes an etching liquid easily permeate into an interface between the copper foil and the etching resist thereon, and results in a formation of an inadequate circuit. Accordingly, the improvement has been demanded in this respect as well.

The above latter technology, in spite of the above described problems, has too important advantage of causing no problem with positioning to neglect. Accordingly, as for the technology of filling a through hole by using a resin-coated copper foil, it has been desired a resin-coated copper foil will not produce any crack in the resin layer having the filled hole or any recess part on the surface copper foil, even when a thermal shock is given to the resin layer in the steps of soldering and mounting a component.

### DISCLOSURE OF THE INVENTION

Thus, the present inventors have intensively researched a solution for the above described problems, and reached the conclusion that they can be solved by adopting a particular blend of a resin composing a resin layer in the resin-coated copper foil according to the present invention. The present invention will be now described below.

The present invention claims, “A resin-coated copper foil characterized in that the resin-coated copper foil has the resin layer on one surface of the copper foil, wherein the resin layer has a resin composition as follows”. The composition of the resin comprises (1) 20 to 70 parts by weight of an epoxy resin, (2) 5 to 30 parts by weight in the total of a high polymer having a crosslinkable functional group in the molecules and a crosslinking agent therefor, and (3) 10 to 60 parts by weight of a compound having a structure shown in Formula 1. 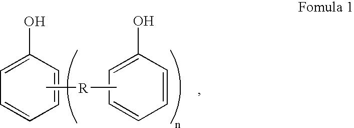
wherein n is an integer of one or more, 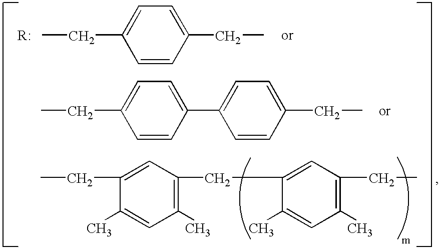
wherein m is an integer of 0 or greater.

Each composition will be now described below. The “epoxy resin” of the component (1) is not particularly limited, but can be used so long as it is usable for a printed wiring board for use in electric and electronic industries. For instance, the epoxy resin includes a bisphenol type, a novolak type, a TBBA-based brominated epoxy resin and a glycidylamine type. In the above composition, a blending amount of the epoxy resin is desirably 20 to 70 parts by weight. Less than 20 parts by weight of the epoxy resin, which is the lower limit, causes a problem of lowered adhesiveness with a copper foil. On the contrary, more than 70 parts by weight of the epoxy resin relatively decreases the amounts of the components (2) and (3) to be used in combination blended into the resin, makes a blending balance inadequate, can not reduce expansion and shrinkage behaviors in the case of receiving a thermal shock, which is the purpose of the present invention, and thereby can not provide a product for practical use.

Next, a polymer component to be used in the component (2) includes the polymers of a polyvinylacetal resin, a phenoxy resin, a polyether sulfone resin, a carboxyl modified acrylonitrile-butadiene resin and an aromatic polyamide resin, which are all soluble in a solvent. These resins need to react with a crosslinking agent which is used in combination with the resins, and form a three-dimensional structure, so that the resin is supposed to contain a crosslinkable functional group in the molecule. Specifically, the resin has to contain one or more groups among an alcoholic hydroxy group, a carboxyl group and a phenolic hydroxy group.

A crosslinking agent to be used in combination with the resin is for example a urethane resin, a phenol resin and a melamine resin. The ratio of a polymer component to the crosslinking agent is experimentally determined, so that the ratio does not require particular limitation but can be easily determined by those skilled in the art.

In addition, each of the polymer component and the crosslinking agent can be used singly or in combination with two or more components, without any problem. These compounds can be necessary for controlling the flow rate of a resin in press working required not only for a resin-coated copper foil but also for inhibiting the formation of a resin powder at the end of a press-worked laminate. When the polymer and the crosslinking agent are added, the addition amount not more than 5 parts by weight with respect to 100 parts by weight of the total amount, causes too high flow rate of the resin in hot-press to make the control difficult, and simultaneously causes remarkable formation of the resin powder from the end of the pressed laminate. On the contrary, if the amount exceeds 30 parts by weight, the resin causes too little flow to realize an adequate press condition, and becomes impractical.

A component (3) has a structure shown in Formula 1 wherein R is any one of the groups shown in the angled brackets in Formula 1. Specifically, these compounds have an aromatic skeleton, contain a —OH group reactive to an epoxy resin, and act as a curing agent for the epoxy resin to make a strong cured resin. When these resins are used as the curing agent for the epoxy resin, the cured substance has toughness because of a reduced cross-linking density in itself, and shows stronger resistance to distortion generated by heat. In addition, because in the cured substance, an aromatic chain exists between hydroxyl groups, heat resistance is not substantially lowered even if the cross-linking density is decreased. Furthermore, because of the low cross-linking density, the compound causes little shrinkage due to curing in the cured substance and are very useful from the viewpoint of preventing the formation of a recess part on the above described copper foil surface. These components (3) are added so as to be in a range of 10 to 60 parts by weight with respect to the total amount of 100 parts by weight. The components (3) in the added amount of less than 10 parts by weight do not develop the effect of preventing the crack at the resin-filled portion when having received a thermal shock, and the components (3) more than 60 parts by weight are unfavorable because the heat resistance of the cured substance becomes insufficient.

The components (1), (2) and (3) have been described, and it has been also described that the crosslinking agent of the polymer component in the above described component (2) includes a urethane resin, a phenol resin and a melamine resin. However, if a crosslinkable functional group in the polymer component in the component (2) is a carboxyl group or a phenolic hydroxy group, the crosslinkable functional group easily reacts with the epoxy resin of the component (1) to become a crosslinking agent, so that the polymer component in the component (2) does not particularly need using other crosslinking agents.

In addition, in order to smoothly promote a curing reaction between the components (1) and (2), a curing accelerator for the epoxy resin can be used as needed. The specific examples of the curing accelerator include a phosphorous curing accelerator for the epoxy resin represented by triphenylphosphine, and curing accelerators for the epoxy resin containing nitrogen such as a tertiary amine, imidazoles, an organic hydrazide and urea.

Furthermore, for the purpose of improving the surface properties of the resin of a resin-coated copper foil, and improving the adhesiveness of the resin to the copper foil, an additive for the resin can be employed. The specific examples are an antifoaming agent, a leveling agent, a coupling agent and the like.

The above described resin components generally are dissolved in a solvent such as methyl ethyl ketone, and the liquid is coated on the surface of the copper foil, and is dried by heating to provide a resin-coated copper foil. The coating method at this time is not particularly limited.

Then, the resin-coated copper foil is laminated on a predetermined inner layer material, and the laminate is pressed and subjected to necessary steps such as a circuit formation and a via hole formation with the use of a laser beam, to provide a multilayer printed wiring board. Thus prepared resin composition can secure a proper fluidity of the resin in the pressing step for a printed wiring board, and shows a property superior in filling and plugging through holes with small diameters such as via holes. In addition, the resin composition imparts a cured substance strong resistance to expansion and shrinkage by thermal shock receiving after curing, so that after the resin-coated copper foil has been processed into a copper-clad laminate, the copper foil on the surface shows few recess parts, and simultaneously shows superior cracking resistance.

### BEST MODE FOR CARRYING OUT THE INVENTION

In the following, with reference to embodiments, the above described invention will be described further in detail.

### Embodiment 1

In the present embodiment, a resin-coated copper foil was produced so as to have a resin layer on a nodular-treated side of an electrodeposited copper foil having a nominal thickness of 18 μm.

First, an epoxy resin composition was prepared which is used for forming the resin layer. Epomik R-140 (made by Mitsui Chemicals) which is a bisphenol A type epoxy resin in the amount of 40 parts by weight was taken for the epoxy resin of the components (1) according to the claim, and the compound (Milex XLC-LL made by Mitsui Chemicals) which has a structure shown in Formula 2 in the amount of 39 parts by weight was taken for the component (3) according to the claim, and both were mixed.

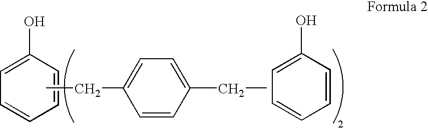

Then, Curezol 2P4MZ (a product made in Shikoku Corp.) was added to the above mixture as a curing accelerator for the epoxy resin, so as to share 1 parts by weight, and the product was dissolved in dimethylformamide so as to make a solution having 50 wt. % a solid content.

Subsequently, 17 parts by weight of Denka Butyral 5000A (made by Denki Kagaku Kogyo) which is a polyvinylacetal resin, and 3 parts by weight of Coronate AP stable (made by Nippon Polyurethane Industry Co.) which is a urethane resin, were added to the above product, as “a high polymer having a crosslinkable functional group in the molecular and a crosslinking agent therefor” which are the component (2) according to the claim.

In this stage, the resin composition was adjusted so as to comprise 80 parts by weight (in terms of a solid content) of an epoxy resin blend, and 20 parts by weight (in terms of a solid content) in total of a polyvinyl acetal resin and a urethane resin, and a mixed solvent consisting of toluene:methanol=1:1. was used to make them form 30 wt % a total solid content.

The above described resin composition was applied to the nodular-treated side of an electrodeposited copper foil having a nominal thickness of 18 μm, was air-dried and then heated at 130° C. for 5 minutes to obtain a resin-coated copper foil having the resin layer of a half cured state. At this moment, the thickness of the resin layer was controlled to 100 to 105 μm.

Then, the above described resin-coated copper foil was bonded to both sides of the inner layer material (of a FR-4 inner layer core material of four layers) of a multilayer printed wiring board having a predetermined circuit and via holes already formed. When bonded, the resin-coated copper foil was stacked and arranged so that the resin layer contacts with the surface of the inner core material, and was press-molded under the pressure of 20 kgf/cm² and at the temperature of 170° C. for two hours, to fill via holes with the resin constituting the resin layer of the resin-coated copper foil and prepare the multilayered copper-clad laminate having the copper foil layers of six layers.

Then, the copper foil of the outer layer in the copper-clad laminate of the six layers was etched to have a circuit formed thereon, and the cross section of the via hole was observed with an optical microscope to confirm the filled state with a resin. As a result, the via hole was uniformly filled with the resin, defects such as a void were not observed, simultaneously no remarkable recess part was not observed on the copper foil, and the recess part merely made the depth of about 1.5 μm by the average of ten points. Furthermore, the substrate after being etched was immersed in a solder bath at 260° C. for 60 seconds to carry out a solder heat resistance test, but the expansion in the via hole and the destruction of the substrate were not observed.

### Embodiment 2

In the present embodiment, by a method basically similar to the embodiment 1, a resin-coated copper foil having the resin layer on the nodular-treated side of the electrodeposited copper foil having the nominal thickness of 18 μm was prepared, except that in place of the compound having the structure shown in Formula 1 used as the component (3) according to the claim, 41 parts by weight of the structure shown in Formula 3 was used to be mixed. However, the amount of the epoxy resin corresponding to the component (1) was made to be 38 parts by weight to equalize the both chemical equivalents. Accordingly, in order to avoid redundant description, only the structure of Formula 3 and the result will be now described.

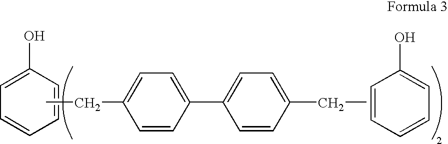

The resin composition obtained in the above method was applied to the nodular-treated side of an electrodeposited copper foil having a nominal thickness of 18 μm, was air-dried and then heated at 130° C. for 5 minutes to obtain a resin-coated copper foil having the resin layer of a half cured state. At this moment, the thickness of the resin layer was controlled to 100 to 105 μm.

Then, the above described resin-coated copper foil was bonded to both sides of the inner layer material (of a FR-4 inner layer core material of four layers) of a multilayer printed wiring board having a predetermined circuit and via holes already formed. When bonded, the resin-coated copper foil was stacked and arranged so that the resin layer contacts with the surface of the inner core material, and was press-molded under the pressure of 20 kgf/cm² and at the temperature of 170° C. for two hours, to fill via holes with the resin constituting the resin layer of the resin-coated copper foil and prepare the multilayered copper-clad laminate having the copper foil layers of six layers.

Then, the copper foil of the outer layer in the copper-clad laminate of the six layers was etched to have a circuit formed thereon, and the cross section of the via hole was observed with an optical microscope to confirm the resin-filled state. As a result, the via hole was uniformly filled with the resin, defects such as a void were not observed, simultaneously no remarkable recess part was not seen on the copper foil, and the recess part merely made the depth of about 1.0 μm by the average of ten points. Furthermore, the etched substrate was immersed in a solder bath at 260° C. for 60 seconds to carry out a solder heat resistance test, but the expansion in the via hole and the destruction of the substrate were not observed.

### Embodiment 3

In the present embodiment, by a method basically similar to the embodiment 1, a resin-coated copper foil having the resin layer on the nodular-treated side of the electrodeposited copper foil having the nominal thickness of 18 μm was prepared, except that in place of the compound having the structure shown in Formula 1 used as the component (3) according to the claim, 39 parts by weight of the compound (Nikanol P-100 made in Mitsubishi Gas Chemical Co.) having the structure shown in Formula 4 was used to be mixed. However, the amount of the epoxy resin corresponding to the component (1) was made to be 40 parts by weight to equalize the both chemical equivalents. Accordingly, in order to avoid redundant description, only the structure of Formula 4 and the result will be now described.

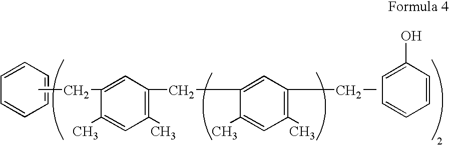

The resin composition obtained in the above method was applied to the nodular-treated side of an electrodeposited copper foil having a nominal thickness of 18 μm, was air-dried and then heated at 130° C. for 5 minutes to obtain a resin-coated copper foil having the resin layer of a half cured state. The thickness of the resin layer was controlled to 100 to 105 μm.

Then, the above described resin-coated copper foil was bonded to both sides of the inner layer material (a FR-4 inner layer core material of four layers) of a multilayer printed wiring board having a predetermined circuit and via holes already formed. When bonded, the resin-coated copper foil was stacked and arranged so that the resin layer contacts with the surface of the inner core material, and was press-molded under the pressure of 20 kgf/cm² and at the temperature of 170° C. for two hours, to fill via holes with the resin constituting the resin layer of the resin-coated copper foil and prepare the multilayered copper-clad laminate having the copper foil layers of six layers.

Then, the copper foil of the outer layer in the copper-clad laminate of the six layers was etched to have a circuit formed thereon, and the cross section of the via hole was observed with an optical microscope to confirm the filled state with a resin. As a result, the via hole was uniformly filled with the resin, defects such as a void were not observed, simultaneously no remarkable recess part was not found on the copper foil, and the recess part merely made the depth of about 2.2 μm by the average of ten points.

Furthermore, the etched substrate was immersed in a solder bath at 260° C. for 60 seconds to carry out a solder heat resistance test, but the expansion in the via hole and the destruction of the substrate were not observed.

### Comparative Example

In the present comparative example, by a method basically similar to the embodiment 1, a resin-coated copper foil having the resin layer on the nodular-treated side of the electrodeposited copper foil having the nominal thickness of 18 μm was prepared, except that in place of the component (3) according to the claim, 26 parts by weight of a phenol novolac resin (with the softening point of 100° C.) which is a compound having the structure shown in the formula was used to be mixed, and at the same time the amount of the epoxy resin of the component (1) was made to be 53 parts by weight in order to equalize the chemical equivalent.

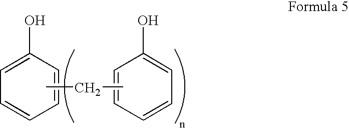

The above described resin-coated copper foil was bonded to both sides of the inner layer material (a FR-4 inner layer core material of four layers) of a multilayer printed wiring board having a predetermined circuit and via holes already formed. When bonded, the resin-coated copper foil was stacked and arranged so that the resin layer contacts the surface of the inner core material, and was press-molded under the pressure of 20 kgf/cm² and at the temperature of 170° C. for two hours, to fill via holes with the resin constituting the resin layer of the resin-coated copper foil and prepare the multilayered copper-clad laminate having the copper foil layers of six layers.

Furthermore, the copper foil of the outer layer in the copper-clad laminate of the six layers was etched to have a circuit formed thereon, and the cross section of the via hole was observed with an optical microscope to confirm the resin-filled state. As a result, the via hole was uniformly filled with the resin, defects such as a void were not observed. However, as a result of observation for the recess parts on the copper foil, the recess parts showed the depth of 5.6 μm by the average of ten points. In addition, the substrate after being etched was immersed in a solder bath at 260° C. for 60 seconds to carry out a solder heat resistance test, and a crack was observed in the resin filled in the via hole.

### Comparison Between Embodiments and Comparative Example

When the embodiments 1 to 3 and the comparative example described above are compared, they clearly show an obvious difference in the respects of the resin-filled condition, the state of the recess parts of the copper foil and the result of the solder heat resistance test, that each above described embodiment causes no problem while the comparative example which adopted the resin blending therein caused the problem. Consequently, it is understood that a printed wiring board using a resin-coated copper foil according to the present invention is superior in a solder heat resistance, and safety and quality stability in a high-temperature load environment such as soldering treatment and reflow soldering treatment.

### INDUSTRIAL APPLICABILITY

The above described resin composition for the resin layer of a resin-coated copper foil according to the present invention, reliably gives the resin of a copper-clad laminate an optimal flowability for filling the through holes having small diameters such as via holes in the press process, and besides, a strong resistance to expansion and shrinkage by thermal shock receiving after the resin has been cured, and a superior cracking resistance when having received heat shock after the copper-clad laminate has been processed. The use of such a resin-coated copper foil facilitates multilayering of an IVH substrate and remarkably improves the production yield.

1. A resin-coated copper foil, wherein the resin-coated copper foil has the resin layer on one surface of the copper foil, wherein the resin layer has a resin composition as follows:
(1) 20 to 70 parts by weight of an epoxy resin
(2) 5 to 30 parts by weight of a high polymer having a crosslinkable functional group in its molecule and a crosslinking agent therefor in combination
(3) 10 to 60 parts by weight of a compound having a structure shown in Formula 1: 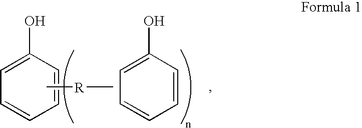
wherein n is an integer of one or more, 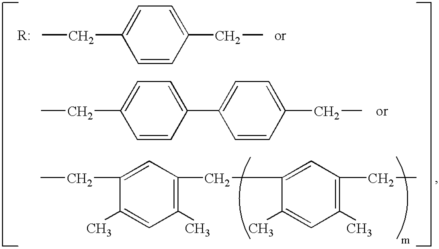
wherin m is an integer of 0 or greater.

2. The resin-coated copper foil according to claim 1, wherein the high polymer having a crosslinkable functional group in its molecule and the crosslinking agent therefor are one or more selected from the group consisting of a polyvinyl acetal resin, a phenoxy resin, a polyethersulfone resin, a carboxyl modified acrylonitrile-butadiene resin and an aromatic polyamide resin polymer, which are all soluble in a solvent.

3. A multilayer printed wiring board, comprising the resin-coated copper foil according to claim 1.

4. A multilayer printed wiring board, comprising the resin-coated copper foil according to claim 2.
